(19) United States
(12) Patent Application Publication
(10) Pub. No.: US 2003/0007061 A1
(43) Pub. Date: Jan. 9, 2003

(54) Image-forming apparatus

(76) Inventor: Ayao Ogawa, Nagano-ken (JP)

Correspondence Address: HOGAN & HARTSON L.L.P., 500 S. GRAND AVENUE, SUITE 1900, LOS ANGELES, CA, 90071-2611, US

(21) Appl. No.: 10/174,516

(22) Filed: Jun. 17, 2002

(30) Foreign Application Priority Data
Jun. 27, 2001 (JP) 2001-194291

(51) Int. Cl. B41J 2/325

(52) U.S. Cl. 347/213

(57) ABSTRACT

There is provided provide an image-forming apparatus that is capable of bringing a transfer film and a print medium into intimate contact without any gap therebetween, to thereby enhancing the quality of an image transferred from the film to the print medium. An image-forming apparatus uses a print medium, and a transfer film formed of a water-soluble resin material and having a smooth printing surface, to form a transferred image on the print medium. An image is printed on the printing surface of the transfer film, with sublimable dye ink. The printed transfer film and the print medium are overlaid such that the printing surface of the transfer film faces a transfer surface of the print medium. The printed transfer film and the print medium overlaid to each other are sandwiched and a thermal pressing process is performed on the printed transfer film and the print medium to cause the image printed on the transfer film to be diffused and fixed on the transfer surface. At this time, a pressure heating roller performs pressure rolling on the printed transfer film and the print medium overlaid to each other, from a non-printing surface side of the transfer film. Alternatively, a pair of pressure heating rollers sandwich the printed transfer film and the print medium overlaid to each other therebetween, and send them forward by rotation thereof.

### BACKGROUND OF THE INVENTION

1. Field of the Invention

This invention relates to an image-forming apparatus that prints an image on a transfer film with sublimable dye ink and thermally transfers the image onto a print medium.

2. Prior Art

Conventionally, image-forming apparatuses are known which print an image on a transfer paper with sublimable dye ink by various printing methods, and thermally transfer the printed image from the transfer paper to a print medium. As one of these apparatuses, there has been proposed an image-forming apparatus based on an ink jet printing method, which ejects ink droplets to the transfer paper to cause the same to be impregnated with the ink droplets, thereby causing the ink droplets to be held by the transfer paper, overlays the printed surface of the transfer sheet on a surface of the print medium, and performs a thermal pressure process with a thermal press to cause the ink droplets held by the transfer sheet to penetrate into the print medium via the printed surface in the laminating direction, thereby dispersing and fixing the ink droplets on a transfer surface of the print medium to form a transferred image thereon.

In the transfer-based image-forming method, it is essential to bring the transfer paper and the print medium into intimate contact with each other under pressure so as to enhance the quality of the image transferred to the print medium. However, the transfer paper has a rough printing surface, which prevents perfect intimate contact of the same with the print medium, and hence microspaces are produced therebetween to cause color variation in the transferred image. Further, the thermal press performs the pressure contact process by surface contact, and the microspaces are liable to be produced by air trapped therebetween, which can hinder proper transfer of the image. Further, the transfer sheet tends to suffer from spreading of ink since the ink droplets ejected thereon is likely to diffuse along the fibers of the paper (feathering), which means that the quality of the image has already been spoiled before execution of the thermal transfer of the image to the print medium.

### SUMMARY OF THE INVENTION

It is an object of the invention to provide an image-forming apparatus that is capable of bringing a transfer film and a print medium into intimate contact without any gap therebetween, to thereby enhance the quality of an image transferred from the film to the print medium.

To attain the above object, according to a first aspect of the invention, there is provided an image-forming apparatus that uses a print medium having a transfer surface, and a transfer film formed of a water-soluble resin material and having a smooth printing surface and a non-printing surface opposite to the printing surface, to form a transferred image on the print medium.

The image-forming apparatus according to the first aspect of the invention is characterized by comprising:

printing means for printing an image on the printing surface of the transfer film, with sublimable dye ink;

overlaying means for overlaying the printed transfer film and the print medium such that the printing surface of the printed transfer film faces the transfer surface of the print medium; and

fixing means for sandwiching the printed transfer film and the print medium overlaid to each other and performing a thermal pressing process on the printed transfer film and the print medium to cause the image printed on the transfer film to be diffused and fixed on the transfer surface of the print medium,

the fixing means having a pressure heating roller for performing pressure rolling on the printed transfer film and the print medium overlaid to each other, from a non-printing surface side of the transfer film.

According to this image-forming apparatus, when an image is printed on the transfer film, the sublimable dye ink is impregnated and held in the transfer film, and when the thermal pressing process is carried out on the print medium with the printing surface of the transfer film overlaid thereto, particles of the sublimable dye ink having sizes at a molecular level are transferred from the transfer film deep into the transfer surface of the print medium to develop color, to thereby form a transferred image thereon. Then, by peeling the transfer film off the print medium, the print medium is produced on which the image is easily formed.

The application of line-contact pressure and heat is effected by the relative rolling of the pressure heating roller on the transfer film. This enables the entire contact surfaces of the transfer film and the print medium to be pressed and heated uniformly and stably. That is, the pressure heating roller continuously brings the transfer film and the print medium into the partial intimate contact while sequentially forcing out air trapped therebetween. This makes it possible to bring the film and the medium into firm intimate contact without forming any microgaps therebetween, whereby a high-quality transferred image can be obtained and the thermal pressing process can be executed continuously to reduce the processing time. It should be noted that when the pressure heating roller is formed by a single roller, means for receiving the pressure contact of the print medium may be formed by a belt conveyor, a pallet or the like, which can also sever as medium transport means to reduce the processing time.

Further, the transfer film is formed of a resin and hence has a smooth printing surface. This makes it easy to force out air trapped between the transfer film and the print medium when pressure is applied thereto, thereby bringing them into as intimate contact as possible. This ensures the intimate contact between the transfer film and the print medium.

Further, the transfer medium is formed as a water-soluble transfer film, which makes it possible to prevent feathering, and realize high ink absorptivity during printing, whereby the ink can be stably impregnated and held in the transfer film without spreading of the ink. This causes the direct transfer of the print image into the surface of the print medium without permeating through the transfer film, and therefore, the image can be transferred faithfully. It should be noted that the transfer film is preferably formed of a soft resin, depending on the material of print medium and the penetration depth of ink.

Preferably, the pressure heating roller comprises an infrared radiation heater, and a rubber roller containing the infrared radiation heater.

According to this preferred embodiment, it is possible to apply heat to the transfer film and the print medium overlaid to each other, uniformly not only in a horizontal direction but also in a direction of depth of the overlaid body, and further bring the film and the medium into pressure contact with a uniform force. This makes it possible to effectively prevent variation of colors caused by transfer and trapping of air to thereby form a high-quality transferred image. It should be noted that the pressure heating roller is preferably formed by winding heat-resistant silicone rubber around a hollow cylindrical roller made of metal, such as stainless steel, and accommodating an infrared lamp within the roller.

Preferably, the printing means comprises an ink jet printer, and the image-forming apparatus further comprises drying means for drying moisture of the ink forming the image printed on the transfer film.

According to this preferred embodiment, while the transfer film is subjected to the thermal pressing process in a state overlaid to the print medium, it has its moisture of the image-forming ink already removed. Therefore, it is possible to effectively prevent color variation and bleeding due to vapor bubbles of moisture of the ink formed during the thermal pressing process.

Preferably, the print medium is a card.

According to this preferred embodiment, a high-quality image can be formed on the card.

To attain the above object, according to a second aspect of the invention, there is provided an image-forming apparatus that uses a print medium having a transfer surface, and a transfer film formed of a water-soluble resin material and having a smooth printing surface and a non-printing surface opposite to the printing surface, to form a transferred image on the print medium.

The image-forming apparatus according to the second aspect of the invention is characterized by comprising:

printing means for printing an image on the printing surface of the transfer film, with sublimable dye ink;

overlaying means for overlaying the printed transfer film and the print medium such that the printing surface of the printed transfer film faces the transfer surface of the print medium; and

fixing means for sandwiching the printed transfer film and the print medium overlaid to each other and performing a thermal pressing process on the printed transfer film and the print medium to cause the image printed on the transfer film to be diffused and fixed on the transfer surface of the print medium,

the fixing means having a pair of pressure heating rollers for sandwiching the printed transfer film and the print medium overlaid to each other therebetween, and sending the printed transfer film and the print medium forward by rotation thereof.

According to this image-forming apparatus, similarly to that according to the first aspect of the invention, a high-quality transferred image can be formed. In doing this, the pair of pressure heating rollers perform the thermally pressing process. Therefore, the pair of pressure heating rollers can bring the transfer film and the print medium into pressure contact with each other while advancing them at a fixed speed. While simplified in configuration, the image-forming apparatus can perform the thermally pressing process continuously and efficiently and effectively prevent the quality of the transferred image being degraded owing to heating variation and pressure variation.

Preferably, the image-forming apparatus further comprises film feed means for continuously feeding the transfer film along the printing means, the overlaying means, and the fixing means, medium feed means for feeding the print medium along the overlaying means and the fixing means, and control means for synchronizing the film feed means and the medium feed means.

According to this preferred embodiment, it is possible to continuously perform a sequence of processing from the printing and the thermally pressing process, and the apparatus as a whole can be simplified in construction and reduce the processing time period.

More preferably, the pair of pressure heating rollers also serve as common feeding rollers of the film feed means and the medium feed means.

According to this preferred embodiment, it is possible to further simplify the construction of the apparatus.

Preferably, the image-forming apparatus includes heating control means for controlling heating of the pair of pressure heating rollers, the heating control means being configured to be capable of individually controlling heating temperatures of the pair of pressure heating rollers.

According to this preferred embodiment, by individually controlling the temperatures of the pair of pressure heating rollers, it is possible to positively prevent the deformation (warpage) of the print medium having the image transferred thereto. For instance, it is possible to properly prevent the deformation (warpage) of the print medium having the image transferred thereto by carrying out the heating processes while taking into account the different thermal expansion coefficients of the transfer film and the print medium resulting from the different manners of overlaying (intimate contact) of them and the different thermal expansion coefficients of each of component layers forming each of them.

Preferably, each of the pressure heating rollers comprises an infrared radiation heater, and a rubber roller containing the infrared radiation heater.

According to this preferred embodiment, it is possible to obtain the same advantageous effects as provided by a corresponding preferred embodiment of the first aspect of the invention.

Preferably, the printing means comprises an ink jet printer, and the image-forming apparatus further comprises drying means for drying moisture of the ink forming the image printed on the transfer film.

According to this preferred embodiment, it is possible to obtain the same advantageous effects as provided by a corresponding preferred embodiment of the first aspect of the invention.

Preferably, the print medium is a card.

According to this preferred embodiment, it is possible to obtain the same advantageous effects as provided by a corresponding preferred embodiment of the first aspect of the invention.

The above and other objects, features, and advantages of the invention will become more apparent from the following detailed description taken in conjunction with the accompanying drawings.

### BRIEF DESCRIPTION OF THE DRAWINGS

FIG. 1 is a cross-sectional view schematically showing the arrangement of an image-forming apparatus according to a first embodiment of the invention;

FIG. 2A is a cross-sectional view of a transfer film for use in the FIG. 1 image-forming apparatus;

FIG. 2B is a cross-sectional view of an inexpensive print medium for use in the FIG. 1 image-forming apparatus;

FIG. 2C is a cross-sectional view of a high-grade print medium for use in the FIG. 1 image-forming apparatus; and

FIGS. 3A to 3E are cross-sectional views schematically illustrating a procedure of an image being printed on the transfer film and transferred therefrom to a print medium to thereby form the transferred image on the print medium.

### DETAILED DESCRIPTION OF PREFERRED EMBODIMENT

The invention will now be described in detail with reference to drawings showing a preferred embodiment thereof. An image-forming apparatus according to an embodiment of the present invention performs thermal transfer of desired images from a water-soluble transfer film onto a print medium in the form of a resin card. More specifically, the apparatus prints an image e.g. of letters, figures, a background, and/or the like, on the transfer film with sublimable dye ink by the ink jet printing method, and then overlays the transfer film onto the print medium after forcibly drying the printed image, followed by thermally transferring the printed image from the transfer film to the print medium to form a high-quality transferred image on the print medium.

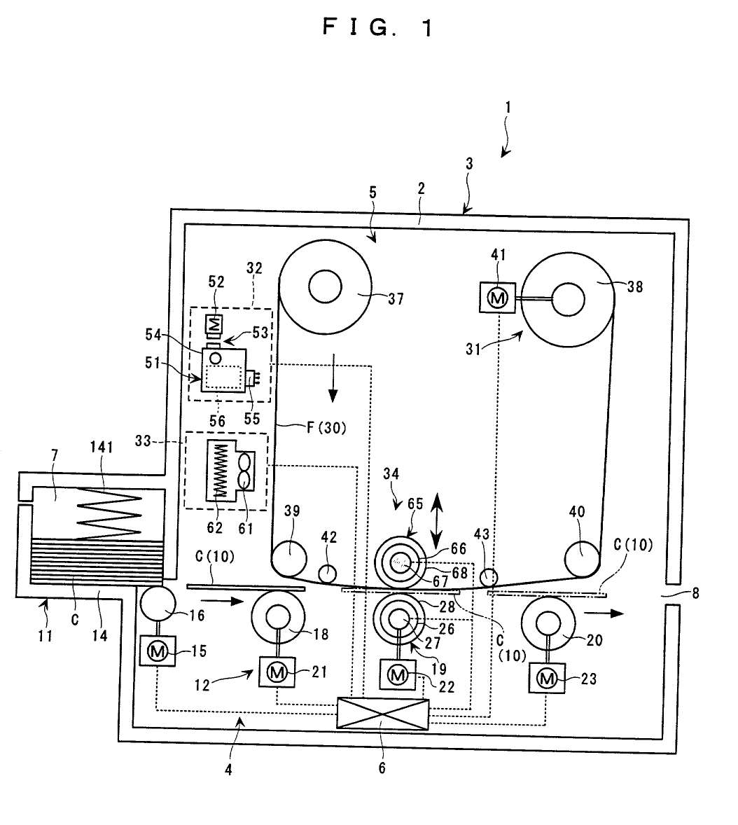

Referring first to FIG. 1, the image-forming apparatus 1 has an apparatus body 3 including an outer shell formed by a box-shaped casing 2, a medium block 4 arranged at a lower location, for transporting the print medium C, a film block 5 arranged at an upper location, for transporting the transfer film F, and a controller 6 for controlling the medium block 4 and the film block 5, individually and in a mutually-related manner. In a left-hand side portion of the casing 2, there is formed a medium supply port (chamber) 7 via which each print medium C is introduced into the apparatus body 3, while in a right-hand side portion of the casing 2, there is formed a medium exit 8 via which the print medium C is delivered out of the apparatus. Further, in the apparatus body 3, a medium transport passage 10 for conveying the print medium C extends horizontally and linearly in a manner communicating between the medium supply port 7 and the print medium exit 8.

The medium block 4 is comprised of medium supply means 11 for supplying the print media C, and medium feed means 12 for transporting each print medium C along the medium transport passage 10. On the other hand, the film block 5 is comprised of film feed means 31 for unwinding a roll of transfer film F to feed the same along the film traveling passage 30, which is generally U-shaped, and taking up the same, printing means 32 for printing on the transfer film by an ink jet printing method, drying means 33 for forcibly drying the printed transfer film F by a hot air, and thermal pressing means 34 for pressing the transfer film F against the print medium C while applying heat thereto. The image-forming apparatus 1 prints a desired image on the transfer film F with sublimable dye ink while feeding the film F, dries the printed transfer film F, aligns and overlays a printed portion of the transfer film F onto the print medium C, thermally presses them to cause the image printed on the transfer film to be transferred onto the print medium C to be fixed therein, and delivers the print medium C via the medium exit 8.

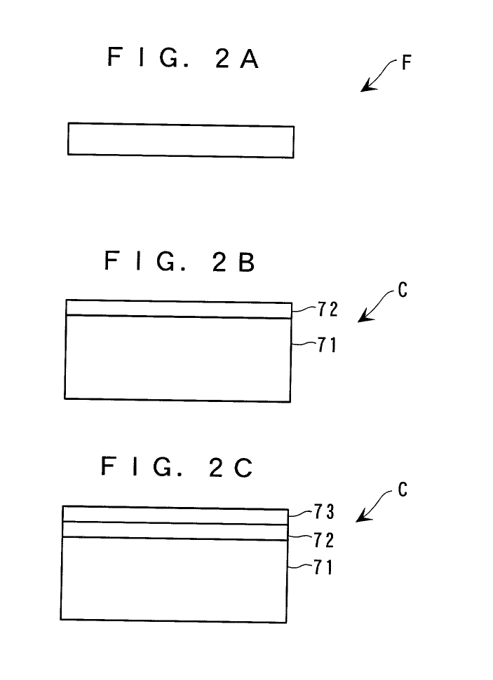

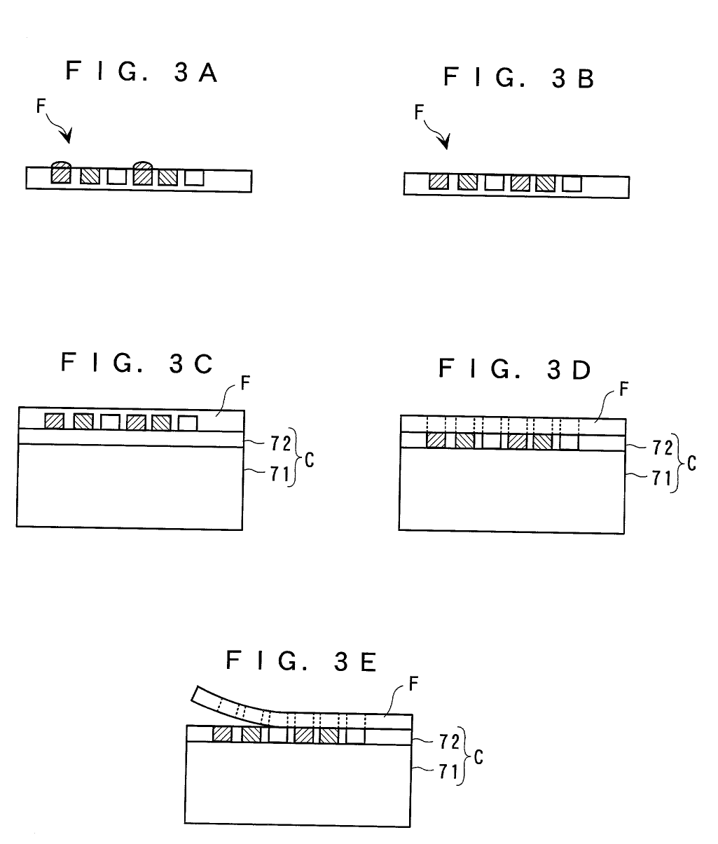

Now, before describing details of components of the image-forming apparatus 1, to make the description thereof easily understandable, in the first place, the transfer film F and the print medium C, and an image-forming process carried out using the film and medium will be described in detail. FIG. 2A is a cross-sectional view of a transfer film for use in the FIG. 1 image-forming apparatus; FIG. 2B is a cross-sectional view of an inexpensive print medium for use in the FIG. 1 image-forming apparatus; and FIG. 2C is a cross-sectional view of a high-grade print medium for use in the FIG. 1 image-forming apparatus. FIGS. 3A to 3E are cross-sectional views schematically illustrating a procedure of an image being printed on the transfer film and transferred therefrom to a print medium to form the transferred image on the print medium.

The transfer film F is a so-called image-receiving sheet, which is formed of a heat-resistant and water-soluble resin material forming a single layer as shown in FIG. 2A. The transfer film F is capable of temporarily holding the sublimable dye ink directly ejected thereon for printing. The water-soluble resin of the transfer film F is composed of a principal component of PVA (polyvinyl alcohol) or pyrrolidone, and receives and holds the sublimable dye ink in a substantially upper half area thereof in the direction of thickness. In the present embodiment, since the transfer film F is formed of a water-soluble resin, it is possible to maintain an excellent ink absorbency for absorbing the sublimable dye ink in the printing process, which allows the sublimable dye ink to be stably impregnated into the transfer film F and held in the same without being diffused.

Further, the transfer film F is composed of not only PVA as the principal component but also the additives of a material which exhibits slight tackiness when pressed and heated and a material which exhibits a slightly curable property when exposed to the air after having been pressed and heated. Therefore, the thermal pressing process causes the transfer film F to exhibit the weak tackiness and firmly stick to the print medium C, while the air from a fan causes the transfer film F to exhibit the slight curable property, thereby making the same easy to separate from the print medium C.

Further, the transfer film F is configured such that it has a smooth printing surface for receiving the sublimable dye ink and is soft as a whole, so as to ensure proper intimate contact with the print medium C. Therefore, when the transfer film F and the print medium C are overlaid to each other and pressed, air and trapped between the contacted surfaces of the transfer film F and the print medium C are expelled to bring the two into intimate contact with each other. However, the transfer film F may be of a hard resin, depending on the kind of the print medium C and the like.

On the other hand, FIGS. 2B and 2C show the laminate structures of the two kinds of print medium C provided in the present embodiment. The print medium C shown in FIG. 2B is comprised of a substrate layer 71 and an ink-fixing layer 72 laminated on a surface of the substrate layer 71, while in the print medium C shown in FIG. 2C, an additional fluorine film layer 73 is laminated on a surface of an ink-fixing layer 72 so as to take the place of a laminating film. In other words, in the FIG. 2B print medium, the ink-fixing layer 72 provides a transfer surface, while in the FIG. 2C print medium, the fluorine film layer 73 provides a transfer surface. The print medium C may be in the form of roll paper, printing tape or cutsheet paper, but in the present embodiment, description will be given by taking cards as an example of the print media.

The substrate layer 71 of each of the print media (cards) C is formed of a plastic film e.g. of PVC (polyvinyl chloride) or PET (polyethylene terephthalate) or a synthetic paper which causes the entire print medium C to have an adequate rigidity. Further, in general, the substrate layer 71 is mainly formed of a basically white-colored material. The ink-fixing layer 72 is formed e.g. of a transparent PET film and serves as a layer into which printed sublimable dye ink finally permeates. In short, a printed image is thermally transferred into the ink-fixing layer 72 and fixed therein. It is preferred that the transfer surface of the print medium C, i.e. the surface of the ink-fixing layer 72 which faces the printing surface of the transfer film F should be also configured to be smooth.

As shown in FIG. 3A, when the image is printed on the transfer film F by the ink jet printing method, ink droplets of the sublimable dye ink are impregnated into the transfer film F and held therein. At this time, the ink droplets are held in the substantially upper half of the transfer film F without being diffused to its neighboring areas. The amount of moisture of ink per unit area depends on the printed image, and therefore, the transfer film in a humid state is dried by blowing hot air thereto to remove the moisture of the ink therefrom (FIG. 3B). Then, the transfer film F is turned upside down and overlaid to the print medium C such that the printing surface of the transfer film F faces the surface of the print medium C (FIG. 3C).

When the print medium C overlaid with the transfer film F is heated under pressure contact with the same, more specifically, in a state of the transfer film F and the print medium C being relatively pressed against each other, the ink droplets penetrate up to the proximity of the boundary between the ink-fixing layer 72 and the substrate layer 71 thereunder as migration particles having sizes at a molecular level (FIG. 3D). In other words, when the ink droplets held in the transfer film F are heated, they penetrate into the ink-fixing layer 72 to be evaporated/diffused and develop color in the ink-fixing layer 72, whereby the image is fixed and formed in the ink-fixing layer 72. Thereafter, the transfer film F is separated from the print medium C (FIG. 3E) to expose the ink-fixing layer 72 to the outside, whereby the print medium (card) C having the image thermally transferred into the ink-fixing layer 72 is produced.

The transfer film F separated from the print medium C exhibits its water-soluble property when immersed in water, and dissolved therein. As a result, it is possible to completely destroy the original image faintly left on the transfer film F, so that forgery of the print medium C can be also prevented.

Similarly, when the FIG. 2C print medium C having the fluorine film layer 73 laminated thereon is used for printing, the heating of the transfer film F causes the ink droplets to pass through the fluorine film layer 73 to be diffused and fixed in the ink-fixing layer 72. Therefore, when the transfer film F is separated, the print medium C is produced which has the fluorine film layer 73 as the outermost surface layer thereof for protecting the image transferred into the ink-fixing layer 72. Thus, the print medium C with the image is made more excellent in weather resistance, light resistance, heat resistance, rub or abrasion resistance, and chemical resistance by the coating of the fluorine film layer 73. Further, the fluorine film layer 73 gives a high gloss to the print medium C.

It should be noted that the print medium C may have a laminate structure symmetrical with respect to the substrate layer 71 such that the thermal transfer of an image can be effected on both sides thereof. Further, it is preferred that the transfer film F is formed to be slightly larger than the print medium C for easy separation from the same. This makes it possible to provide a peeling margin for the transfer film F and carry out proper image transfer even up to all edges of the print medium C (so-called edge-to-edge printing/transfer). Moreover, since it is possible to fix ink even in the substrate layer 71 depending on the degree of heating, the transparent ink-fixing layer 72 can be dispensed with for reduction of manufacturing costs.

Next, the details of the components of the image-forming apparatus 1 will be described, starting with the medium block 4. The medium feed means 11 is comprised of a medium cassette 14 containing a plurality of print media C in a stacked manner, a feed motor 15 as the drive source, and a feed roller 16 rotated by the feed motor 15. The medium cassette 14 is formed by projecting a portion of the casing 2 outward to define the aforementioned medium supply port 7 therein, and has an inner plane shape generally similar to the plane shape of the print medium C. Further, the medium cassette 14 has a predetermined depth which allows a plurality of print media C to be set in a stacked manner. When in a closed state, the upper surface (transfer surface) of the topmost print medium C is pressed downward by a spring 141 provided in the medium cassette.

The feed roller 16 is arranged under a front portion of the medium cassette 14 in a manner held in rolling contact with a forward portion of the underside surface of a lowermost one of the stacked print media C. The feed motor 15 is connected to the controller 6 for control of rotation of the feed roller 16. A front (feeding-side) wall of the medium cassette 14 extends downward to a location below which the lowermost print medium C alone is allowed to pass. The rolling contact of the feed roller 16 on the print medium at the lower most position ensures that the print media C are reliably fed one by one to the medium feed means 12.

The medium feed means 12 is comprised of a send-in roller 18 arranged at a location in the vicinity of the feed roller 16 and on a upstream portion of the medium transport passage 10, a heating roller 19 arranged on an intermediate portion of the passage 10, a send-out roller 20 arranged on a downstream portion of the passage 10, and a send-in motor 21, a heating motor 22, and a send-out motor 23, as respective drive sources of these rollers 18, 19, 20. The heating roller 19 not only forms a main component of the thermal pressing means 34, but also plays part of the function of the medium feed means 12 for feeding the print medium C in the direction of the send-out roller 20.

The send-in roller 18 is in rolling contact with the bottom of the print medium C sent from the feed roller 16 and sends the print medium C along the medium transport passage 10 toward the heating roller 19. The send-in motor 21 is connected to the controller 6 for control of the rotation of the send-in roller 18. That is, the send-in roller 18 is controlled by the controller 6 such that it is rotated in synchronism with the feeding of the transfer film F by the film feed means 31, for sending the print medium C toward the heating roller 19 such that the printed portion of the transfer film F and the print medium C are accurately overlaid to each other at a location of the thermal pressing means 34.

The heating roller 19 is comprised of a roller body 26 in a hollow cylindrical form of stainless steel, an infrared lamp 27 contained as a heat source within the heater body 26, and a rubber roll 28 wound around the outer peripheral surface of the roller body 26. The infrared lamp 27 is formed by a halogen lamp, and has its heating operation controlled by the controller 6 to keep the heating roller 19 at a temperature uniformly raised along the length thereof. The rubber roll 28 is formed by a heat-resistant silicone rubber, and brought into direct contact with the bottom of the print medium C while receiving the heat generated by the infrared lamp 27 via the roller body 26. The heating roller 19 has a predetermined length corresponding to the width of the print medium C and the bottom of the medium C is brought into rolling contact therewith.

The heating motor 22 is connected to the controller 6 for control of the rotation of the heating roller 19. That is, the heating roller 19 performs rotation in synchronism with the feeding of the transfer film F by the film feed means 31, and cooperates with a thermal pressing roller 65 of the thermal pressing means 34 to sandwich the print medium C therebetween and feed the same by rotation of the rollers. More specifically, the print medium C has the transfer film F overlaid to its ink-fixing layer 72 as the top thereof such that the layer 72 faces toward the thermal pressing roller 65, and the heating roller 19 and the thermal pressing roller 65 firmly sandwich the film F and medium C from both sides to send them by rotation at a fixed speed, whereby the film F and medium C are advanced along the medium transport passage 10 toward the send-out roller 20.

The send-out roller 20 is arranged in the vicinity of the medium exit 8 such that the bottom of the print medium C is brought into rolling contact therewith, whereby the print medium C sent from the heating roller 19 is forwarded along the medium transport passage 10 toward the medium exit 8. The send-out motor 23 is connected to the controller 6 for control of the rotation of the send-out roller 20. Thus, the print medium C is sent along the medium transport passage 10 in a horizontal position. It should be noted that although in the present embodiment, the send-in motor 21, the heating motor 22, and the send-out motor 23 are provided separately for the rollers, respectively, a single drive source may drive the rollers in a synchronizing manner for rotation at a fixed speed via a driving force-transmitting mechanism.

Next, the construction of each component of the film block 5 will be described in detail. The film feed means 31 is comprised of a supply reel 37 arranged at an upper left-hand location as viewed in the figure, for rolling out the transfer film F, a take-up reel 38 arranged at an upper right-hand location as viewed in the figure, for taking up the transfer film F, a first guide roller 39 for guiding the transfer film F rolled out from the supply reel 37 to the printing means 32 and the drying means 33, a second guide roller 40 for guiding the transfer film F from the first guide roller 39 to the thermal pressing means 34, a take-up motor 41 for driving the take-up reel 38, and a pair of passage projections 42, 43 arranged at respective locations upstream of and downstream of the thermal pressing means 34. The supply reel 37, the first guide roller 39, and the second guide roller 40 are freely rotatable members, and the first guide roller 39, the thermal pressing means 34, the second guide roller 40, and the pair of passage projections 42, 43 define a film traveling passage 30 extending from the supply reel 37 to the take-up reel 38. It should be noted that the film traveling passage 30 partially join the medium transport passage 10 at the location of the thermal pressing means 34.

The supply reel 37 is arranged upstream of the printing means 32. Around the supply reel 37 is wound the un-used transfer film F in the form of a roll. The transfer film F is wound around the supply reel 37 such that the printing surface of the film F rolled out can face a head unit 51, referred to hereinafter, of the printing means 32. The first guide roller 39 is arranged at a location downstream of the drying means 33 such that it faces toward the send-in roller 18 on the opposite side of the medium transport passage 10. The supply reel 37 and the first guide roller 39 are disposed at the respective locations on opposite sides of the printing means 32 and the drying means 33 and define part of the film traveling passage 30 parallel to the head unit 51 and the drying means 33, along which the transfer film F is fed. That is, the supply reel 37 and the first guide roller 39 brings the transfer film F to a printing position in front of the printing means 33 and a drying position in front of the drying means 33, in parallel with the respective means 32, 33.

Of the pair of passage projections 42, 43, the first passage projection 42 is arranged between the first guide roller 39 and the thermal pressing means 34, while the second passage projection 43 is arranged between the thermal pressing means 34 and the second guide roller 40. These passage projections 42, 43 are arranged in parallel with the film traveling passage 30 so as to position the transfer film F in parallel with the medium transport passage 10. That is, the printed and dried transfer film F traveling from the first guide roller 39 while being guided by the first passage projection 42 has its printing surface positioned to face the print medium C in parallel therewith between these passage projections 42, 43.

The take-up reel 38 is driven for rotation by the take-up motor 41 to take up the transfer film F after being thermally pressed. More specifically, the transfer film F is rolled out from the supply reel 37 by rotation of the take-up reel 38 and taken up by the take-up reel 38. The take-up motor 41 is connected to the controller 6 for control of the rotation of the take-up reel 38. That is, the take-up reel 38 is rotated in synchronism with the medium feed means 12 that feeds the print medium C, and sends the transfer film F along the film traveling passage 30.

The second guide roller 40 is arranged between the take-up reel 38 and the second passage projection 43 such that it faces toward the send-out roller 20 on the opposite side of the medium transport passage. More specifically, the second guide roller 40 guides the transfer film F which is being taken up by the take-up reel 38 after passing the thermal pressing means 34 and the second passage projection 43, such that the transfer film F is fed in an inclined or oblique direction with respect to the medium transport passage 10. In short, the second guide roller 40 not only guides the feed of the transfer film F but also serves as separating means for separating the transfer film F, which has been overlaid to the print medium C by the thermal pressing means 34, from the print medium C.

It should be noted that a film cartridge comprised of the supply reel 37, the take-up reel 38, and the transfer film F accommodated in a single cartridge casing may be provided such that it can be removably mounted in the casing 2. In this case, the film cartridge may be configured such that the film traveling passage 30 for the transfer film F is defined within the cartridge casing and openings are formed through the same at locations corresponding to the thermal pressing roller 65, the head unit 51, and the drying means 33, etc. This makes it possible to facilitate the handling of the transfer film F during transport thereof, including storage of the same.

The printing means 32 is implemented by an ink jet printer which is comprised of a head unit 51, a carriage motor 52 as a drive source, and a reciprocating mechanism 53 which receives torque from the carriage motor 52 to reciprocate the head unit 51. The printing means 32 is connected to the controller 6. The head unit 51 is comprised of an ink jet head 55 having a plurality of nozzles formed in one end face thereof, an ink cartridge 56 which supplies sublimable dye ink to the ink jet head 55, and a carriage 54 carrying the ink jet head 55 and the ink cartridge 56. The ink cartridge 56 contains four colors (yellow (Y), cyan (C), magenta (M), and black (B)) of sublimable dye ink. Otherwise, it may contain six colors of sublimable dye ink, i.e. the above four colors plus two colors (light cyan (LM) and light magenta (LM).

When the reciprocating mechanism 53 causes the carriage 54 to reciprocate, ink droplets are ejected, from the ink jet head 55, whereby printing is effected on the transfer film F. More specifically, while the transfer film F is fed or advanced intermittently by the film feed means 31 to pass along the film traveling passage 30 before the head unit 51, the head unit reciprocates in a direction orthogonal to the feeding direction to carry out printing on the transfer film F. That is, printing operation is performed by the ink jet print method using the sublimable dye ink such that the <reciprocating motion of the head unit 51 and the feed of the transfer film F serve as the main scanning and the sub scanning in printing technology.

The sublimable dye ink is an ink of a sublimable dye material and sublimed by heat, as described above. More specifically, in the printing process, the sublimable dye ink is impregnated into the transfer film F and temporarily held in the same. Then, the sublimable dye ink is transferred to the print medium C by heat generated in heat treatment for thermal transfer, and diffused/evaporated in the print medium C to develop color. It should be noted that the printing means 32 preferably prints on the transfer film F such that a mirror image is formed thereon, so as to form a real image on the print medium C.

The drying means 33 is arranged downstream of the printing means 32, and formed by a dryer which faces the transfer film F sent thereto in a non-contacting manner. The dryer 33 is comprised of a fan 61 for blowing air toward the film traveling passage 30, and a nichrome wire heater 62 for heating the air blown by the fan 61. The dryer 33 faces the transfer film F with a predetermined distance therefrom, and blows the air to the printed image to dry the same. That is, the transfer film F has its humid printed image exposed to the hot air to be thereby forcedly dried, and after thus having the moisture of ink of the printed image vaporized, it is sent forward to the thermal pressing means 34.

It should be noted that the forcible drying of the transfer film F can be controlled by the factors of a quantity of air blown by the dryer 33 and an amount of heat generated by the same and the factor of a feeding speed of the transfer film F, as described in detail hereinafter. Further, the casing 2 is preferably formed with an air inlet gallery, not shown, (air inlet port) and an air outlet gallery (air outlet port) which open into a passage of an air stream generated by the fan 61.

The thermal pressing means 34 is comprised of the heating roller 19 positioned at the lower location, the thermal pressing roller 65 opposed to the heating roller 19 across the medium transport passage 10 and the film traveling passage 30, and a lift mechanism and an urging member, neither of which is shown, for moving down and up the thermal pressing roller 65 toward and away from the heating roller 19. The thermal pressing roller 65 faces toward a location where the film traveling passage 30 and the medium transport passage 10 meet, and configured similarly to the heating roller 19, except that it performs free rotation. More specifically, the thermal pressing roller 65 is comprised of a hollow cylindrical roller body 66 of stainless steel, an infrared lamp 67 contained as a heat source within the roller body 66, and a rubber roll 68 wound around the outer peripheral surface of the roller body 26.

The thermal pressing roller 65 has a predetermined length corresponding to the width of the print medium C (transfer film F), and is brought into rolling contact with the non-printing side of the transfer film F. As described in detail hereinafter, by individually controlling the temperature of each of the thermal pressing roller 65 and the heating roller 19, it is possible to cleverly prevent deformation, e.g. warpage of the print medium C which might occur after being sent out of the medium exit 8 with an image fixed thereon.

The lift mechanism includes an urging member, such as a spring, and moves up and down the thermal pressing roller 65 as required, to thereby adjust the pressure applied to the heating roller 19 (transfer film F). More specifically, the transfer film F with the bottom thereof, which is the printing surface, facing toward the heating roller 19, has the nonprinting side thereof pressed against the thermal pressing roller 65 which is rotated with rotation of the heating roller 19. That is, the transfer film F and the print medium C are heated while being firmly held from above and below and advanced forward by rotation of the rollers at the fixed speed. This applies the heat and pressure to the transfer film F and the print medium C in line contact with each other, to cause the sublimable dye ink held in the transfer film F to be sequentially transferred to the print medium C to thereby transfer the printed image to the print medium C, i.e. form a transferred image thereon.

The controller 6 is comprised of a CPU for controlling various operations of the image-forming apparatus 1, a ROM for storing control programs and data for controlling various means, a RAM for use as various work areas for carrying out the corresponding control processes, and respective drive circuits for driving the essential blocks of the image-forming apparatus 1. The controller 6 controls the various means individually and in a mutually-related manner. Although, not particularly shown, within the casing 2, there are also arranged two sensors to face toward the film traveling passage 30 with the printing means 32 between them, which are connected to the controller 6, as well as one sensor at a location downstream of the printing means 32 and one sensor in the vicinity of the send-in roller 18, arranged to face the medium transport passage 10 with the dry means 33 between them. These sensors detect the printing and drying positions of the transfer film F, and based on each detected position, the print medium C sent by the send-in roller 18 is controlled such that it is properly aligned and overlaid to the printed and dried portion of the transfer film F at the location of the thermal pressing means 34. The controller 6 performs adequate and accurate control, especially of the drying means 33, the film feed means 31, and the thermal pressing means 34 such that a high-quality transferred image is formed on the print medium C.

Now, the control process by the controller 6 will be described, mainly on control processes carried out for the drying means 33 and the thermal pressing means 34. The controller 6 causes the printing means 32 to print on the transfer film F based on image information prepared by a personal computer (PC) or the like. Further, the controller 6 determines the amount of heat to be generated by the drying means 33 (determined by the heating temperature and heating duration), the quantity of air, and the film feeding speed of the film feed means 31, by looking up its own condition table prepared by taking into account the factor of properties (material, type, thickness) of the transfer film F, and based on printing information (mainly of an amount of ink) for the printing process executed on the transfer film F by the printing means 32.

More specifically, the controller 6 starts the drying means 33 after printing is effected on the transfer film F, and drives the drying means 33 such that it performs drying operation with a predetermined amount of heat and/or a predetermined quantity of air, based on the printing information for the printing executed on the transfer film F. At the same time, the controller 6 causes the film feed means 31 to advance the transfer film F at the film feeding speed dependent on the predetermined amount of heat and/or the predetermined quantity of air, over a predetermined time period, while exposing the transfer film F to the drying means 33. It should be noted, in this case, that the feeding speed of the transfer film F by the film feed means 31 may be made fixed, and only the amount of heat and/or the quantity of air may be controlled to simplify the control of the drying means 33. Further, it is also possible to set the feeding speed to zero, i.e. stop the feeding of the transfer film F, and in this state, the transfer film may be exposed to the drying means 33.

After sufficiently drying the printed portion of the transfer film F, the operation of the drying means 33 is stopped, the controller 6 causes the film feed means 31 and the medium feed means 12 to feed the transfer film F and the print medium C in a synchronized manner such that the printed and dried portion of the transfer film F is properly aligned and overlaid to the print medium C at the location of the thermal pressing means 34.

The printing information is based on a total amount of ink used per unit image (per one print on the transfer film F), and details of the information will be described based on examples. When a print image is printed with an enhanced resolution, that is, with a resolution enhanced by increasing the number of dots printed per unit area either by increasing the number of times of ejection of ink from the ink jet head 55 or by increasing the number of ejection nozzles of the head 25, or with an enhanced reproducibility of intermediate tones of colors of the image by multi-value recording in which a plurality of ink droplets are ejected per dot, the amount of heat and/or the quantity of air are/is set to higher values than normal.

Further, when an image is printed by using a composite black formed by mixing the three colors (Y, C, M) for the black B of sublimable dye ink, it necessarily increases the amount of ink per unit area (unit ink ejection amount). Therefore, in this case, the drying process by the drying means 33 etc. is controlled by taking into account the use of the composite black therefor in calculation of the unit ink ejection amount.

Further, in performing the edge-to-edge printing, which is demanded in the case of the print medium C being a card, a solid fill print is formed which has an increased print area and increased unit ink ejection amount, and therefore, the drying processing is controlled to an increased amount of heat generated therefor. Thus, the transfer film F with the printed image and in a humid state is dried to an adequate extent in advance, and stably sent to the thermal pressing means 34 at the following stage in a state with the moisture of ink having been vaporized off.

Next, the control process for the thermal transfer means 34 will be described in detail. The controller 6 controls the heating conditions, etc. of the thermal transfer means 34 by looking up its own condition table prepared by taking into account the factor of material, etc. of the print medium C. More specifically, the controller 6 determines the heating temperatures of the thermal pressing roller 65 and the heating roller 19, and the pressing force of the thermal pressing roller 65, the film feeding speed and the medium feeding speed. Alternatively, the image-forming apparatus 1 may be linked to a PC storing attribute information of the transfer film F and the print medium C, so as to determine the heating conditions and the like based on the information.

Now, the control process based on the determined heating conditions etc., and a flow thereof will be described. The controller 6 causes the thermal pressing roller 65 and the heating roller 19 to be driven for heating at a predetermined heating temperature. In doing this, the infrared lamps 27, 67 of the rollers 19, 65 are started but they are individually controlled to the temperatures so as to prevent the print medium C from undergoing deformation (warpage) after the image is transferred thereto. More specifically, the heating temperatures of the rollers 19, 65 (infrared lamps 27, 67) are set by taking into account the different thermal expansion coefficients of the transfer film F and the print medium C resulting from the different manners of overlaying (intimate contact) of them and the different structures of component layers forming each of them.

Then, the film feed means 31 and the medium feed means 12 (send-in roller 18) causes the transfer film F and the print medium C to be sent forward such that they are properly aligned between the rollers 19, 65. Then, the film feed means 31 and the medium feed means 12 (heating roller 19) send forward the transfer film F and the print medium C simultaneously by rotation of the rollers at the feeding speed and with the adjusted pressing force of the thermal pressing roller 65 dependent on the heating temperatures. It should be noted that the control of the amount of applied heat may be simplified by setting the feeding speeds of the film feed means 31 and the medium feed means 12 to a fixed value, and controlling only the heating temperatures. Further, the feeding speeds of the respective means 31, 12 may be determined depending on the resolution of a printed image.

Thus, the transfer film F and the print medium C are brought into rolling contact with the thermal pressing roller 65 and the heating roller 19 so as to be sent forward in the feeding direction while being pressed and heated by line contact, sequentially from the leading end thereof, thereby causing air trapped at the interface of the film F and the medium C to be forced out. That is, the transfer film F and the print medium C are sent forward over a predetermined time period whereby the image printed on the transfer film is thermally transferred to the print medium C. Then, the transfer film F is taken up after being separated from the print medium C, and the print medium having the printed image transferred thereto is sent out via the medium exit 8 and supplied to users.

The image-forming apparatus 1 constructed as above performs the thermal pressing process for the transfer of an image by line-contact pressure and heat application using the thermal pressing roller 65 and the heating roller 19. Therefore, the pressure and heat are uniformly applied to the entire contact surfaces of them in a state forcedly brought into firm contact with each other without forming any micro-gaps between them. This makes it possible to obtain a high-quality transferred image and continuously perform the thermal pressing process, thereby reducing the processing time period.

It should be noted that depending on the manner of intimate contact between the transfer film F and the print medium C and the layered structure of each of them, the heating temperature of the infrared lamp 27 of the heating roller 19 may be controlled to be set to a temperature slightly lower than the heating temperature of the infrared lamp 67 of the thermal pressing roller 65. Further, in the thermal pressing process, only the thermal pressing roller 65 may be driven for heating by taking the energy efficiency into account. Further, the drying means 33 may be formed by a radiation type, such as a halogen lamp, in place of the dryer 33 employed in the present embodiment.

Although in the present embodiment, the heating roller 19 provides means for bearing the pressure applied to the print medium C by the thermal pressing roller 65 via the transfer film F in intimate contact therewith, this is not limitative, but the means for receiving the pressure contact of the print medium C may be of a belt type, and after being placed on the conveyer belt (with the bottom of the print medium C supported thereon), the print medium C may be sent along the medium transport passage 10 so as to be brought to the thermal pressing roller 65 positioned above. In this case, similarly to the above, it is possible to continuously perform partial intimate contact between the transfer film F and the print medium C while the thermal pressing roller 65 sequentially forces out air trapped between the transfer film F and the print medium C.

Further, although in the present embodiment, the transfer film F is continuously fed by causing the same to be traveled and taken up, this is not limitative, but the printed portion of the film F may be cut off on the way, and the thermal pressing process may be carried out on the cut printed portion of the film F and the print medium C by overlaying the former to the latter, and then causing the thermal pressing roller 65 to be pressed and relatively rolled on the film F from the non-printing side thereof.

Further, it is preferred that a preheating plate is arranged on the film traveling passage 30 at a location between the printing means 32 and the drying means 33, for preheating the transfer film F at a lower temperature in a non-contacting manner. This brings the transfer film F which is humid due to printing to the drying means 33 in a state warmed by the preheating, so that the drying means 33 can finish the main drying process in a reduced time. Further, due to the arrangement of the preheating plate between the printing means 32 and the drying means 33, these means are spaced from each other by a predetermined distance, whereby it is possible to conveniently prevent the air blown by the fan 61 from directly affecting the operation of the ink jet head 56 of the printing means 32.

It is further understood by those skilled in the art that the foregoing is a preferred embodiment of the invention, and that various changes and modifications may be made without departing from the spirit and scope thereof.

What is claimed is:

1. An image-forming apparatus that uses a print medium having a transfer surface, and a transfer film formed of a water-soluble resin material and having a smooth printing surface and a non-printing surface opposite to the printing surface, to form a transferred image on the print medium,
the image-forming apparatus comprising:
printing means for printing an image on the printing surface of the transfer film, with sublimable dye ink;
overlaying means for overlaying the printed transfer film and the print medium such that the printing surface of the printed transfer film faces the transfer surface of the print medium; and
fixing means for sandwiching the printed transfer film and the print medium overlaid to each other and performing a thermal pressing process on the printed transfer film and the print medium to cause the image printed on the transfer film to be diffused and fixed on the transfer surface of the print medium,
said fixing means having a pressure heating roller for performing pressure rolling on the printed transfer film and the print medium overlaid to each other, from a non-printing surface side of the transfer film.

2. An image-forming apparatus according to claim 1, wherein said pressure heating roller comprises an infrared radiation heater, and a rubber roller containing the said infrared radiation heater.

3. An image-forming apparatus according to claim 1, wherein said printing means comprises an ink jet printer,
the image-forming apparatus further comprising drying means for drying moisture of the ink forming the image printed on the transfer film.

4. An image-forming apparatus according to claim 1, wherein said print medium is a card.

5. An image-forming apparatus that uses a print medium having a transfer surface, and a transfer film formed of a water-soluble resin material and having a smooth printing surface and a non-printing surface opposite to the printing surface, to form a transferred image on the print medium,
the image-forming apparatus comprising:
printing means for printing an image on the printing surface of the transfer film, with sublimable dye ink;
overlaying means for overlaying the printed transfer film and the print medium such that the printing surface of the printed transfer film faces the transfer surface of the print medium; and
fixing means for sandwiching the printed transfer film and the print medium overlaid to each other and performing a thermal pressing process on the printed transfer film and the print medium to cause the image printed on the transfer film to be diffused and fixed on the transfer surface of the print medium,
said fixing means having a pair of pressure heating rollers for sandwiching the printed transfer film and the print medium overlaid to each other therebetween, and sending the printed transfer film and the print medium forward by rotation thereof.

6. An image-forming apparatus according to claim 5, further comprising:
film feed means for continuously feeding the transfer film along said printing means, said overlaying means, and said fixing means,
medium feed means for feeding the print medium along said overlaying means and said fixing means, and
control means for synchronizing said film feed means and said medium feed means.

7. An image-forming apparatus according to claim 6, wherein said pair of pressure heating rollers also serve as common feeding rollers of said film feed means and said medium feed means.

8. An image-forming apparatus according to claim 5, including heating control means for controlling heating of said pair of pressure heating rollers, said heating control means being configured to be capable of individually controlling heating temperatures of said pair of pressure heating rollers.

9. An image-forming apparatus according to claim 5, wherein each of said pressure heating rollers comprises an infrared radiation heater, and a rubber roller containing said infrared radiation heater.

10. An image-forming apparatus according to claim 5, wherein said printing means comprises an ink jet printer,
the image-forming apparatus further comprising drying means for drying moisture of the ink forming the image printed on the transfer film.

11. An image-forming apparatus according to claim 5, wherein said print medium is a card.
